(19) United States
(12) Patent Application Publication
(10) Pub. No.: US 2025/0289493 A1
(43) Pub. Date: Sep. 18, 2025

(54) STEERING COLUMN FOR A MOTOR VEHICLE

(71) Applicants: thyssenkrupp Presta AG, Eschen (LI); thyssenkrupp AG, Essen (DE)

(72) Inventor: Thomas RAICH, Vandans (AT)

(73) Assignees: thyssenkrupp Presta AG, Eschen (LI); thyssenkrupp AG, Essen (DE)

(21) Appl. No.: 19/074,597

(22) Filed: Mar. 10, 2025

(30) Foreign Application Priority Data
Mar. 12, 2024 (DE) 10 2024 106 986.4

(51) Int. Cl. B62D 1/19; B62D 1/181

(52) U.S. Cl. CPC B62D 1/192; B62D 1/181

(57) ABSTRACT

A steering column for a motor vehicle comprises an actuator in which a steering spindle is mounted so as to be rotatable about a longitudinal axis extending in a longitudinal direction, a casing unit in which the actuator is held so as to be displaceable in the longitudinal direction, and an energy absorption device incorporated between the casing unit and the actuator, the energy absorption device including a deformation strip that is elongate in the longitudinal direction and is fastened to the actuator or the casing unit, and a deformation slide that cooperates with said deformation strip, is attached to the casing unit or the actuator, engages around the deformation strip, and has in each case a pair of retaining knobs and deformation knobs that protrude towards side faces of the deformation strip, wherein the retaining knobs are held in the longitudinal direction against retaining protrusions of the deformation strip, wherein the deformation knobs are arranged at a distance from the retaining knobs in the longitudinal direction and are at a transverse distance from one another which is less than the width of the deformation strip between the mutually opposite side faces extending in the longitudinal direction, and wherein breakaway protrusions that protrude from the side faces are formed in the longitudinal direction in front of the deformation knobs.

### CROSS REFERENCE TO RELATED APPLICATION

This application is a U.S. Non-Provisional that claims priority to German Patent Application No. DE 10 2024 106 986.4, filed Mar. 12, 2024, the entire content of which is incorporated herein by reference.

### FIELD

The present disclosure relates to a steering column for a motor vehicle.

### BACKGROUND

In a steering column of this type, the steering wheel is attached to the rear end, with regard to the direction of travel, of the steering spindle, which is mounted in the actuator in a casing tube, also referred to as inner casing or inner casing tube, so as to be rotatable about a longitudinal axis extending in the longitudinal direction. The actuator is held by a carrier unit which is mounted on the vehicle body.

In order to improve occupant safety in the event of a vehicle impact, also referred to as a crash, in which a body strikes the steering wheel at high speed, it is known for the actuator to be accommodated so as to be flexibly displaceable in the longitudinal direction relative to the carrier unit, for example arranged telescopically in a casing unit, also referred to as an outer casing or outer casing tube, and for an energy absorption device, which is also referred to as a crash system, to be coupled in between the actuator and the casing unit.

If, in the event of a crash, a high force peak, also known as the crash force, exceeding a predefined limit value, is exerted on the steering wheel by a body hitting the steering wheel, the actuator and the casing unit are pushed together in the longitudinal direction. In the process, an energy absorption element, attached between the actuator and the casing unit, of the energy absorption device is plastically deformed and absorbs the kinetic energy introduced in the longitudinal direction by converting it into deformation work, such that the body striking the steering wheel is decelerated in a controlled manner and the risk of injury is reduced.

The cited prior art proposes attaching a deformation strip (energy absorption strip), for example a strip-like metal plate, that is elongate in the longitudinal direction, as energy absorption element to the actuator in the longitudinal direction. A deformation slide is attached as deformation member to an outer casing of the carrier unit, the deformation slide engaging around longitudinal-side side-face longitudinal sides of the deformation strip that are opposite one another transversely to the longitudinal direction. This deformation strip is accommodated in a passage, which is continuous in the longitudinal direction, in the deformation slide, in which a pair of two deformation knobs that are opposite one another in the longitudinal direction are arranged, which are directed towards the side faces of the deformation portion of the deformation strip. In this case, the open passage, which corresponds to the transverse distance between the deformation knobs, is narrower than the width of the deformation portion between the side faces, measured transversely to the longitudinal direction.

In the event of a crash, the deformation slide is moved in the longitudinal direction along the deformation strip and is pulled through between the deformation knobs, wherein the side faces are plastically squashed together continuously transversely to the longitudinal direction along the active length of the deformation portion. This results in effective energy absorption.

In the normal operating state of the motor vehicle, before a crash, the energy absorption device is fixed and secured in the rest state by a holding arrangement. In this regard, the prior art, for example CN 112429072 B or DE 10 2020 212 481 A1, describes retaining knobs which, at a distance from the deformation knobs in the longitudinal direction, likewise protrude in pairs towards the deformation strip. In the rest state, the retaining knobs lie against retaining protrusions which protrude laterally from the deformation strip and which block the movement of the deformation slide in the longitudinal direction in a form-fitting manner. In the event of a crash, the retaining knobs are moved forward, with the retaining protrusions being plastically deformed, such that the energy-absorbing movement of the deformation knobs relative to the side faces is enabled.

In order to ensure secure fixing in normal operation, the retaining knobs are secured to the deformation strip without play, for example clamped in place frictionally and braced against the retaining protrusions. This determines the retaining force that has to be overcome for breakaway in the event of a crash in order that the deformation slide is released and can carry out its energy-absorbing relative movement forward. The level of the retaining force is relatively sensitive to dimensional and production tolerances, however, and so the breakaway force that is crucial for the demanded energy absorption characteristic may be impaired.

For fixing purposes, the deformation strip may have recesses which are formed in the region of the retaining protrusions and into which the retaining knobs engage in the rest state before a crash-preferably without play in and counter to the longitudinal direction. This ensures an optimal retaining action.

Thus a need exists to allow improved breakaway of the energy absorption device in the event of a crash.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a steering column according to the disclosure in a schematic perspective illustration.

FIG. 2 shows an energy absorption device of a steering column according to FIG. 1 in an exposed illustration.

FIG. 3 shows the energy absorption device according to FIG. 2 in an exposed view.

FIG. 4 shows a longitudinal section through the energy absorption device according to FIG. 3.

FIG. 5 shows an enlarged detail view of FIG. 4.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The invention relates to a steering column for a motor vehicle, comprising an actuator in which a steering spindle is mounted so as to be rotatable about a longitudinal axis extending in a longitudinal direction, a casing unit in which the actuator is held so as to be displaceable in the longitudinal direction, and an energy absorption device incorporated between the casing unit and the actuator, having a deformation strip that is elongate in the longitudinal direction and is fastened to the actuator or the casing unit, and a deformation slide that cooperates with said deformation strip, is attached to the casing unit or the actuator, engages around the deformation strip, and has in each case a pair of retaining knobs and deformation knobs that protrude towards side faces of the deformation strip, wherein the retaining knobs are held in the longitudinal direction against retaining protrusions of the deformation strip, and wherein the deformation knobs are arranged at a distance from the retaining knobs in the longitudinal direction and are at a transverse distance from one another which is less than the width of the deformation strip between the mutually opposite side faces extending in the longitudinal direction.

In the case of a steering column for a motor vehicle, comprising an actuator in which a steering spindle is mounted so as to be rotatable about a longitudinal axis extending in a longitudinal direction,

a casing unit in which the actuator is held so as to be displaceable in the longitudinal direction, and an energy absorption device incorporated between the casing unit and the actuator, having a deformation strip that is elongate in the longitudinal direction and is fastened to the actuator or the casing unit, and a deformation slide that cooperates with said deformation strip, is attached to the casing unit or the actuator, engages around the deformation strip, and has in each case a pair of retaining knobs and deformation knobs that protrude towards side faces of the deformation strip,

wherein the retaining knobs are held in the longitudinal direction against retaining protrusions of the deformation strip,

and wherein the deformation knobs are arranged at a distance from the retaining knobs in the longitudinal direction and are at a transverse distance from one another which is less than the width of the deformation strip between the mutually opposite side faces extending in the longitudinal direction, the invention proposes that breakaway protrusions that protrude from the side faces are formed in the longitudinal direction in front of the deformation knobs.

According to the invention, additional breakaway protrusions that are operatively assigned to the deformation knobs are provided. These breakaway protrusions protrude from the side faces in front of the deformation knobs on the side facing away from the retaining protrusions in the longitudinal direction, and are plastically deformable, with energy being absorbed by the deformation knobs, in the event of a crash, with a relative movement forward, i.e. directed away as seen from the retaining protrusions. The breakaway protrusions are arranged in a starting region of the side faces such that, after the start of the relative displacement of the actuator and casing unit, they are plastically deformed by the deformation knobs.

The breakaway protrusions are preferably formed as a pair on the two side faces, preferably symmetrically.

Since the deformation strip has a greater width measured transversely to the longitudinal direction in the region of the breakaway protrusions than in the region of the side faces, an increased force is necessary in order to move the deformation slide in the longitudinal direction over the breakaway protrusions with energy-absorbing plastic deformation in the event of a crash. In this way, the breakaway protrusions can realize a defined force threshold, which can also be referred to as breakaway force or breakaway peak. The breakaway force required to overcome this force threshold is greater than the level of the deformation force that is required in order to move the deformation slide forward outside the breakaway protrusions according to the invention with plastic deformation of the side faces by the deformation knobs.

The level of the breakaway peak may be defined by the dimensions of the breakaway protrusions, in other words by the amount to which they protrude laterally, i.e. transversely to the longitudinal direction, from the side faces. In this case, the level of the breakaway peak is all the greater, the more the breakaway protrusions protrude.

An advantage of the invention is that the breakaway force can be defined independently of the configuration of the retaining arrangement formed by the retaining knobs and the retaining protrusions. As a result, it is possible to overcome the conflict of objectives both of ensuring secure and play-free fixing in the rest position before a crash and of defining the course of energy absorption in the event of a crash reproducibly with low tolerances.

By way of the invention, the fixing of the energy absorption device in the rest state during normal operation of the motor vehicle can be decoupled from the generation of a defined breakaway behaviour in the event of a crash. In this way, the deceleration of a body striking the steering column in the event of a crash can be defined better and evened out, thereby minimizing the risk of injury and increasing the safety level.

Preferably, the breakaway protrusions are arranged in a starting portion of the side faces. The starting portion is defined as being that portion of the side faces that faces the deformation slide and, at the start of a relative movement in the event of a crash, is plastically deformed first by the deformation knobs that are moved forward in the process. As a result, it is advantageously possible to provide an initial breakaway peak which has to be overcome in the event of a crash at the start of the energy-absorbing relative movement of the actuator and casing unit. This can advantageously be configured independently of the fixing in the rest state.

Advantageously, the length of the breakaway protrusions is less than the length of the side faces. With their length measured in the longitudinal direction, the breakaway protrusions preferably extend along a subregion of the length of the side faces, which is plastically deformed by the deformation slide in the event of a crash. Preferably, the length of the breakaway protrusions is less than 10% compared with the total length of the deformable side faces. The length of the breakaway peak can be defined by varying the length.

It is preferably possible for a deformation portion to adjoin the breakaway protrusions. The deformation portion may preferably extend from the side of the breakaway protrusions that faces away from the deformation slide to the end of the possible breakaway travel, i.e. the end portion of the deformation strip, which is plastically deformable by the deformation knobs in the event of a crash with a relative movement. In the deformation portion of the side faces, the width, measured transversely to the longitudinal direction, between the side faces is less than in the region of the breakaway protrusions according to the invention. According to the invention, the breakaway protrusions protrude laterally, i.e. transversely to the longitudinal direction, from the deformation portion.

Preferably, the side faces may extend in a parallel manner, such that, with a relative movement in the event of a crash, a deformation force that is substantially constant over the deformation travel can be generated, which is less than the initial breakaway peak.

Provision may preferably be made for the distance between the retaining protrusions and the breakaway protrusions to be greater than the distance between the retaining knobs and the deformation knobs. The distance is measured in each case in the longitudinal direction, preferably between the contact regions, in the longitudinal direction, of the retaining knobs and of the deformation knobs, which face the retaining protrusions and the breakaway protrusions, respectively, and accordingly face the retaining knobs and deformation knobs, respectively, between the contact regions of the retaining protrusions and the starting regions of the breakaway protrusions, respectively. In the rest state, i.e. in the normal operating state of a steering column before a crash, the retaining knobs preferably lie against the retaining protrusions in a form-fitting manner and without play, with the result that the deformation strip and the deformation slide are fixed relative to one another. In this rest state, there is a defined distance in the longitudinal direction between the deformation knobs and the breakaway protrusions, this being defined by the difference in the distances between the retaining protrusions and the breakaway protrusions, for the one part, and between the retaining knobs and deformation knobs, for the other part. As a result, with the relative movement in the event of a crash, first of all the retaining knobs are moved forward in the longitudinal direction over the retaining protrusions, thereby releasing the fixing, and subsequently the deformation knobs come into deforming contact with the breakaway protrusions. In this way, after releasing from the retaining position, an initialization phase of the energy absorption device takes place, in which the deformation slide can preferably be moved further substantially freely relative to the deformation strip, until the deformation knobs reach the breakaway protrusions according to the invention, and, as described above, the actual breakaway peak is generated. An advantage of this arrangement is that the releasing of the fixing generated by the retaining knobs and the retaining protrusions can be decoupled from the breakaway of the energy absorption device. Consequently, impairment of the energy-absorbing characteristic by material and dimensional tolerances of the fixing can be precluded.

Provision may preferably be made for the retaining force generated between the retaining knobs and the retaining protrusions to be less than the breakaway force generated between the deformation knobs and the breakaway protrusions. Since the retaining or fixing force is less than the breakaway peak, it is possible to ensure that, in the event of a crash, the deformation slide is reliably released from being fixed by the retaining knobs before the breakaway device formed according to the invention by the deformation knobs and the breakaway protrusions is activated. It is advantageous here that tolerances with regard to the retaining force have almost no influence on the energy-absorbing characteristic.

Provision may be made for an assembly portion to be formed between the retaining protrusions and the breakaway protrusions, the assembly portion having a width which is less than the transverse distance between the deformation knobs. In the operating or rest state before a crash, when the retaining knobs are positioned and fixed to the retaining protrusion, the deformation knobs are mounted in the assembly portion, i.e. in the longitudinal direction in front of the actual deformation portion, which encompasses, in its total longitudinal extent, the breakaway protrusions according to the invention and the side faces that are deformable with a relative movement. For assembly, the deformation slide is placed from above, transversely to the longitudinal direction, on the deformation strip, wherein the assembly portion is accommodated between the deformation knobs. As a result of the smaller width relative to the passage between the deformation knobs, the deformation slide can be assembled easily, wherein, in the rest position, there is play in the transverse direction between the deformation knobs and the lateral boundary faces of the assembly portion. As a result, the deformation knobs, in the event of a crash, can be moved forward with play and with negligible friction in the region of the assembly portion until they reach the starting region of the deformation portion, where plastic deformation starts in the event of a crash, and where the breakaway protrusions can preferably be arranged. Besides the easier assembly, this has the advantage that there is no potentially detrimental friction when the deformation slide is released from the retaining device in the event of a crash and is located in the initialization phase before the generation of the breakaway peak.

It is possible for the casing unit to be held in a carrier unit so as to be adjustable in a vertical direction. As a result, it is possible, in a manner known per se, to realize upward and downward vertical adjustment transversely to the longitudinal direction. To this end, the casing unit can be mounted on the carrier unit, which is able to be assembled on the vehicle body, in a region that is at the front in the direction of travel and remote from the steering wheel so as to be pivotable upwards and downwards about a horizontal pivot axis arranged transversely to the longitudinal direction. As a result, the steering wheel attached to the rear of the steering spindle can be vertically adjusted.

Provision may be made for the actuator to have a casing tube which is arranged telescopically in a casing unit. A steering column having a longitudinally adjustable casing arrangement made of casing tubes that are arranged in a casing unit so as to be simply or multiply adjustable telescopically is known per se. The energy absorption device can be coupled in between two casing tubes.

It is possible for the carrier unit to have a tensioning device which is able to be put into a fixing position or a release position, wherein the actuator is secured relative to the carrier unit in the fixing position and is adjustable relative to the carrier unit in the release position. By way of the tensioning device, the actuator can be braced releasably with the casing unit in order to allow longitudinal adjustment in the release position. If vertical adjustment is provided, the actuator can also be braced releasably on the carrier unit in order to allow vertical adjustment in the release position. The actuation can be effected manually, for example via a manually operable tension lever which cooperates with a tensioning device known per se, such as a V-pulley, cam or tilt pin arrangement, in order to selectively fix the steering setting during driving operation or to allow adjustment for adaptation to the driving position in the release position.

In an advantageous embodiment, provision may be made for a motor-operated adjustment drive to be arranged between the casing unit and the actuator. The adjustment drive may comprise, for example, a spindle drive having a spindle nut arranged on a threaded spindle, and having an electric drive motor by way of which the threaded spindle and the spindle nut are able to be driven in rotation relative to one another. Such adjustment drives are known in principle in the prior art and are considered to be reliable and robust. In this case, the spindle nut is attached to the casing unit so as not to be displaceable in the longitudinal direction, and the threaded spindle is attached to the actuator that is telescopic relative thereto. The spindle nut or the threaded spindle is driven in rotation by a drive motor via a separate gear, for example a worm gear or belt drive, with the result that the threaded spindle or spindle nut that is rotationally fixed relative thereto is moved in translation in the direction of the spindle axis, and, depending on the relative direction of rotation, the casing unit and the actuator are moved together or apart in the longitudinal direction.

For vertical adjustment, a motor-operated adjustment drive of similar configuration can be incorporated in the vertical direction between the actuator or casing unit and the carrier unit. If necessary, the longitudinal and vertical adjustment drive can be combined.

In the various figures, identical parts are always provided with the same reference signs and are therefore each generally mentioned only once.

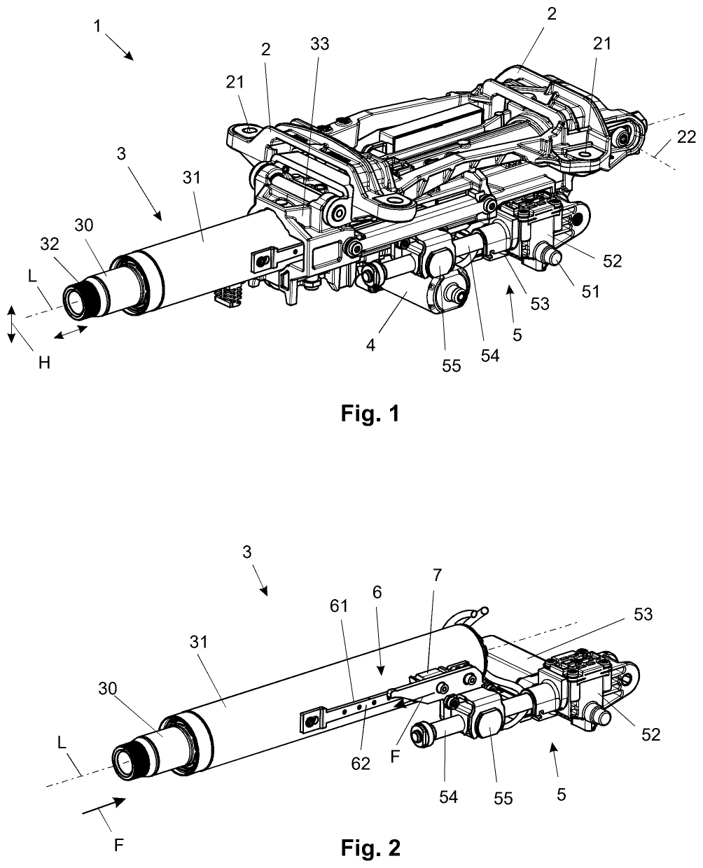

In FIG. 1, a steering column 1 according to the invention is illustrated schematically in a perspective view obliquely from the front (with regard to the direction of travel of a motor vehicle that is not shown).

The steering column 1 can be fastened to the body of a motor vehicle (not illustrated) by means of a carrier unit 2. For connecting to the vehicle body, the latter comprises fastening means 21, which are in the form of fastening openings here.

An actuator 3 comprises a steering spindle 30, which is mounted in an inner casing tube 31, also referred to as internal casing tube or inner casing, so as to be rotatable about its longitudinal axis L extending in the longitudinal direction. Formed at the rear of the steering spindle 30 is a fastening portion 32 for fastening a steering wheel (not illustrated) for the manual input of steering commands. The inner casing tube 31 is accommodated and held in a casing unit 33 so as to be telescopically displaceable in the longitudinal direction, as indicated by the double arrow.

To realize vertical adjustment, the casing unit 33 is mounted on the carrier unit 2 so as to be pivotable about a horizontal pivot axis 22, such that the steering spindle 30 can be moved up and down in a vertical direction H, as is indicated by the double arrow. The vertical adjustment can be effected by means of a motor-operated adjustment drive 4, which is indicated only schematically here, and can be formed, for example, as a spindle drive in a manner known per se, which is operatively attached between the casing unit 33 and the carrier unit 2.

For longitudinal adjustment, an adjustment drive 5 constructed as a spindle drive is provided. The latter comprises a drive unit 51, a drive housing 52, a motor 53, a threaded spindle 54 and a spindle nut 55. The drive housing 52 is fixed axially to the casing unit 33 and supported in the longitudinal direction. The threaded spindle 54 lies substantially parallel to the longitudinal axis L, and the spindle nut 55 acts in the direction of the longitudinal axis L on the casing unit 31 of the actuator 3.

As a result of the threaded spindle 54 being rotated by means of the drive unit 51, the actuator 3 can, depending on the direction of rotation, be extended or retracted telescopically in the longitudinal direction relative to the casing unit 33, as is indicated by a double arrow.

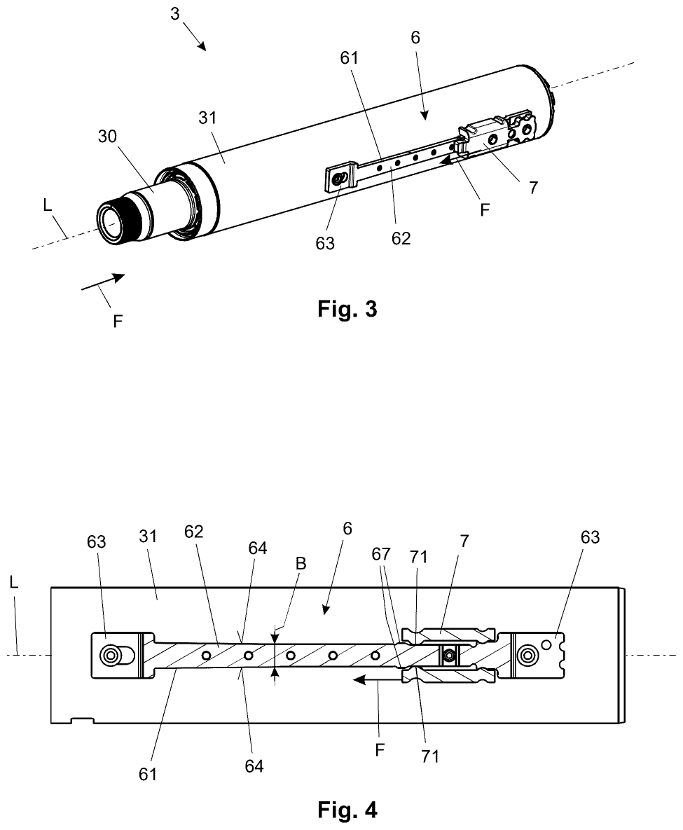

FIG. 2 and FIG. 3 show the actuator 3 in a schematically exposed view in the same perspective as FIG. 1, wherein, in FIG. 2, the casing unit 33 and the carrier unit 2, and in FIG. 3 also the adjustment drive 5, have been omitted for greater clarity.

Attached between the actuator 3 and the casing unit 33 is an energy absorption device 6 configured according to the invention. The latter comprises an energy absorption element in the form of a deformation strip 61, which has a strip-like deformation portion 62 that is elongate in the longitudinal direction. The deformation strip 61 is fixed, in its end regions, to the inner casing tube 31 via fastening portions 63.

The energy absorption device 6 has a deformation slide 7, which, as can be seen in FIG. 2, is connected to the spindle nut 55. As a result, it is supported against the casing unit 33 in the longitudinal direction via the adjustment drive 5.

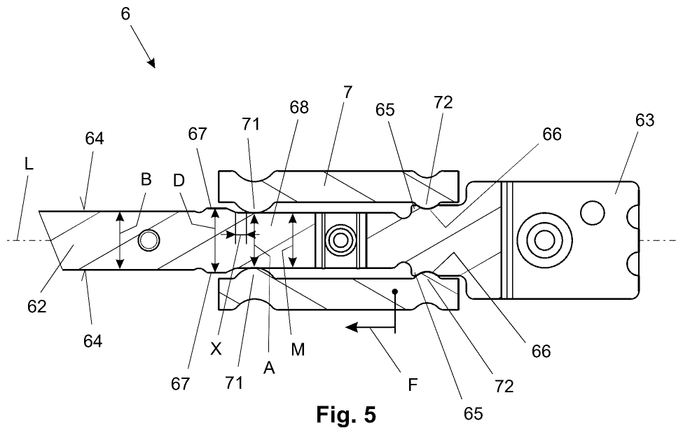

The energy absorption device 6 is shown in detail in a sectional view in FIGS. 4 and 5, wherein the section plane extends parallel to the longitudinal axis L through the deformation portion 62.

The deformation portion 62 has two parallel opposite side faces 64 that extend in the longitudinal direction, and has a width B there.

The deformation slide 7 engages around the deformation strip 61 and has a pair of deformation knobs 71 which are directed from the outside against the side faces 64 in the passage in which the deformation strip 61 is accommodated. In the passage, the deformation knobs are at a transverse distance A from one another which is less than the width B of the deformation portion 62.

At a distance from the deformation knobs 71 in the longitudinal direction, the deformation slide 7 has a pair of retaining knobs 72, which likewise protrude in the passage towards the deformation strip 61.

In front of the retaining knobs 72 in the longitudinal direction, the deformation strip 61 has laterally protruding retaining protrusions 65. These support the retaining knobs 72 in a form-fitting manner in the longitudinal direction and hold the deformation slide 7 relative to the deformation strip 61.

It is possible, but not necessary, for the deformation strip 61 to have recesses 66 formed in the region of the retaining protrusions 65, in which recesses the retaining knobs 72 engage-preferably without play in and counter to the longitudinal direction-in the rest state, shown in the figures, before a crash. As a result, the deformation slide 7 can be held without play in the longitudinal direction relative to the deformation strip 61.

From the side faces 64, two breakaway protrusions 67 according to the invention protrude laterally, transversely to the longitudinal direction. In the region of the breakaway protrusions 67, the deformation strip 61 has a width D which is greater than the width B between the side faces 64 in the deformation portion 62.

In the longitudinal portion between the retaining protrusions 65 and the breakaway protrusions 67, an assembly portion 68 can be formed, in which the width M is less than the open width A of the passage between the deformation knobs 71.

In the example shown, the distance in the longitudinal direction between the retaining knobs 72 and the deformation knobs 71 is less than the distance between the retaining protrusions 65 and the breakaway protrusions 67. As a result, in the rest state, the deformation knobs 71 are at a distance X from the breakaway protrusions 67, located in front of them in the longitudinal direction, that corresponds to the difference between these distances.

In the event of a crash, a crash force F can be exerted on the steering spindle 30 by a body striking the steering wheel, this crash force acting in the longitudinal direction between the deformation slide 7 and the deformation strip 61. FIGS. 3, 4 and 5 indicate how this crash force F acts on the deformation slide 7, and urges this, as defined, forward in the force direction in the direction of the deformation portion 62.

Under the effect of the crash force F, first of all the retaining protrusions 65 are squashed away plastically forward in the longitudinal direction by the retaining knobs 72, such that the deformation slide 7 moves forward in the force direction relative to the deformation strip 61. Subsequently, the deformation knobs 71 travel along the distance X until they reach the breakaway protrusions 67. Within this movement portion, the friction is negligibly low as a result of the guidance with play in the narrow assembly portion 68.

When the deformation knobs 71 hit the breakaway protrusions 67, the deformation thereof generates a defined, high force peak, referred to as the breakaway peak, which can be defined by the level of the breakaway protrusions 67 relative to the deformation portion 62.

Once the deformation knobs 71 have passed over the breakaway protrusions 67 with plastic deformation, there follows the deformation of the side faces 64 in the deformation portion 62, wherein, as a result of the smaller width B (compared with the width D), the necessary deformation force is less than the breakaway peak generated by the breakaway protrusions 67.

The energy-absorbing deformation can be continued uniformly until the kinetic energy introduced by the crash has been preferably entirely converted into deformation work and heat.

### List of Reference Signs

1 Steering column
2 Carrier unit
21 Fastening means
22 Pivot axis
3 Actuator
31 Inner casing tube, casing tube
32 Fastening portion
33 Casing unit
4 Adjustment drive (vertical adjustment)
5 Adjustment drive (longitudinal adjustment)
51 Drive unit
52 Drive housing
53 Motor
54 Threaded spindle
55 Spindle nut
6 Energy absorption device
61 Deformation strip
62 Deformation portion
63 Fastening portion
65 Retaining protrusion
66 Recess
67 Breakaway protrusion
68 Assembly portion
7 Deformation slide
71 Deformation knobs
72 Retaining knobs
L Longitudinal axis
H Vertical direction
F Crash force
B Width of 62
A Transverse distance between 71
D Width between 67
M Width of 68
X Distance of 71 from 67

1. A steering column for a motor vehicle, comprising:
an actuator in which a steering spindle is mounted so as to be rotatable about a longitudinal axis extending in a longitudinal direction;
a casing unit in which the actuator is held so as to be displaceable in the longitudinal direction; and
an energy absorption device incorporated between the casing unit and the actuator, including:
a deformation strip that is elongate in the longitudinal direction and is fastened to the actuator or the casing unit; and
a deformation slide that cooperates with said deformation strip, is attached to the casing unit or the actuator, engages around the deformation strip, and has in each case a pair of retaining knobs and deformation knobs that protrude towards side faces of the deformation strip;
wherein the retaining knobs are held in the longitudinal direction against retaining protrusions of the deformation strip;
wherein the deformation knobs are arranged at a distance from the retaining knobs in the longitudinal direction and are at a transverse distance from one another which is less than the width of the deformation strip between the mutually opposite side faces extending in the longitudinal direction;
wherein breakaway protrusions that protrude from the side faces are formed in the longitudinal direction in front of the deformation knobs.

2. The steering column according to claim 1, wherein the breakaway protrusions are arranged in a starting portion of the side faces.

3. The steering column according to claim 1, wherein the length of the breakaway protrusions is less than the length of the side faces.

4. The steering column according to claim 1, wherein a deformation portion adjoins the breakaway protrusions.

5. The steering column according to claim 1, wherein the distance between the retaining protrusions and the breakaway protrusions is greater than the distance between the retaining knobs and the deformation knobs.

6. The steering column according to claim 1, wherein the retaining force generated between the retaining knobs and the retaining protrusions is less than the breakaway force generated between the deformation knobs and the breakaway protrusions.

7. The steering column according to claim 1, wherein an assembly portion is formed between the retaining protrusions and the breakaway protrusions, the assembly portion having a width which is less than the transverse distance between the deformation knobs.

8. The steering column according to claim 1, wherein the casing unit is held in a carrier unit so as to be adjustable in a vertical direction.

9. The steering column according to claim 1, wherein the actuator has a casing tube which is arranged telescopically in the casing unit.

10. The steering column according to claim 1, wherein the carrier unit has a tensioning device which is able to be put into a fixing position or a release position, wherein the actuator is secured relative to the carrier unit in the fixing position and is adjustable relative to the carrier unit in the release position.

11. The steering column according to claim 1, wherein a motor-operated adjustment drive is arranged between the casing unit and the actuator.
